(19) United States
(12) Patent Application Publication
(10) Pub. No.: US 2008/0154158 A1
(43) Pub. Date: Jun. 26, 2008

(54) MASSAGING ANTI-FATIGUE MAT

(76) Inventor: Don W. Brown, Medina, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/959,860

(22) Filed: Dec. 19, 2007

Related U.S. Application Data
(60) Provisional application No. 60/870,881, filed on Dec. 20, 2006.

(51) Int. Cl. A61H 23/02

(52) U.S. Cl. 601/15

(57) ABSTRACT

An anti-fatigue mat includes an enclosure and electrical circuitry positioned within the enclosure capable of providing at least one electrical current. A vibrating mechanism is coupled to the electrical circuitry for receiving the electrical current and for vibrating in response to the electrical current, thereby providing a vibrating sensation. A compressible composition is positioned within the enclosure.

### CROSS-REFERENCE TO RELATED APPLICATIONS

This application claims priority under 35 U.S.C. §119(e)(1) to U.S. Provisional Patent Application Ser. No. 60/870,881, filed Dec. 20, 2006, entitled “Massaging Anti-Fatigue Mat”, and bearing Attorney Docket No. B542.101.102.

### BACKGROUND

The present disclosure relates to an anti-fatigue mat. More specifically, the present disclosure relates to an anti-fatigue mat incorporating vibration and heat, thereby providing improved blood circulation and reducing user fatigue.

Traditionally, employers struggle with how to protect employees from the discomfort of standing in a relative stationery position for long periods. People who stand for long periods suffer from excessive stress on the feet, legs, back, and other muscles and body parts. Further, excessive standing can lead to varicose veins and to arch and heel pain from flattened feet.

Various types of traditional anti-fatigue mats are used to provide a cushion for a person standing on the mat. However, fatigue and poor circulation often results when a person stands on a traditional anti-fatigue mat for an extended period of time. Persons who work standing up most of the day, such as persons in industries including or incorporating hairdressers, bartenders, cashiers, assembly line workers, security guards, lunch line workers, bank tellers, etc., experience fatigue and poor circulation after standing on a conventional anti-fatigue mat for long periods of time.

While anti-fatigue mats constructed from foams, rubbers, or gels, are known, a need exists for an anti-fatigue mat capable of providing improved comfort and blood circulation to a user.

### SUMMARY

An anti-fatigue mat includes an enclosure and electrical circuitry positioned within the enclosure capable of providing at least one electrical current. A vibrating mechanism is coupled to the electrical circuitry for receiving the electrical current and for vibrating in response to the electrical current, thereby providing a vibrating sensation. A compressible composition is positioned within the enclosure.

### BRIEF DESCRIPTION OF THE DRAWINGS

FIG. 1 is a perspective view of an anti-fatigue mat in accordance with the present disclosure.

FIG. 2 is a perspective view of another anti-fatigue mat in accordance with the present disclosure

FIG. 3 is a sectional view of an anti-fatigue mat in accordance with the present disclosure.

### DETAILED DESCRIPTION

Standing requires about twenty percent more energy than sitting. The human foot includes twenty-five bones, fifty-six ligaments, thirty-eight muscles, and over seven thousand nerve endings. In addition, being farthest from the heart, the feet generally have the poorest circulation in the body, which diminishes with age. Discomfort, pain, fatigue, and poor circulation can lead to further injuries affecting muscles, joints, and blood circulation, not only within the foot, but also within the legs, hips, back, and other body parts.

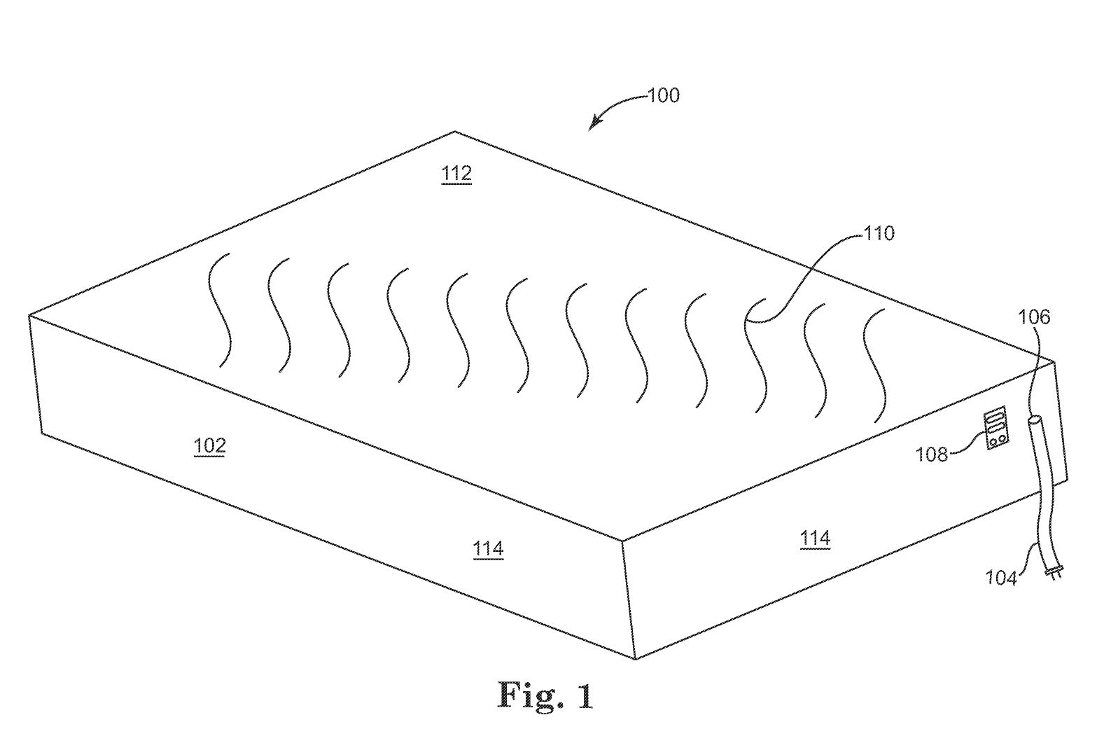

FIG. 1 is a perspective view of anti-fatigue mat 100 in accordance with the present disclosure. Anti-fatigue 100 includes enclosure 102, electrical cord and adapter 104, electrical connect/disconnect 106, manual control 108, anti-slip coating 110, top surface 112, and side surfaces 114.

Anti-fatigue mat 100 aids the softening or cushioning of the body part-to-floor contact. In many industries or situations, employees or persons have to stand for prolonged periods of time. In industries including or incorporating hairdressers, bartenders, cashiers, assembly line workers, security guards, lunch line workers, bank tellers, etc., a person's foot or feet can be in contact directly or indirectly with anti-fatigue mat 100. In other industries or situations, such as daycares and camping, the entire body or multiple body parts, such as knees, bottom, back, or stomach, can be in contact, directly or indirectly, with anti-fatigue mat 100.

While anti-fatigue 100 is shown in FIG. 1 having a square or rectangular three-dimensional design, it is understood that anti-fatigue mat 100 may be constructed in any configuration or shape without deviating from the present disclosure. The height, width, thickness, and overall configuration of anti-fatigue mat 100 may vary without deviation from the present disclosure. For example, anti-fatigue mat 100 may be formed of any shape to fit a desired space of a standing worker in such industries including or incorporating as hairdressers, bartenders, cashier, assembly line workers, security guards, lunch line workers, bank tellers, etc., or may be of a shape to fit the space of a kneeling, sitting, or laying person in a variety of settings such as a home setting, a daycare facility, or a camping setting.

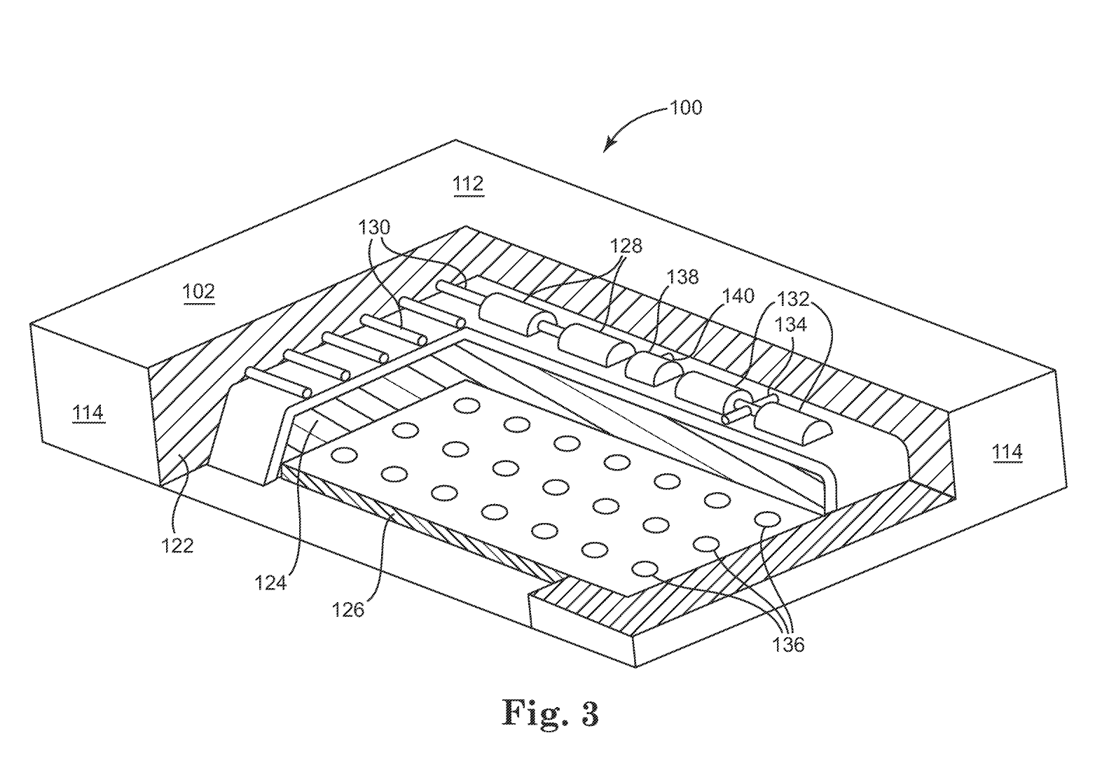

In one embodiment, top surface 112 includes anti-slip coating 110 positioned thereon. Anti-slip coating 110 prevents slipping or unwanted movement when standing on anti-fatigue mat 100. A similar coating may be positioned on the bottom surface of anti-fatigue mat 100 to further prevent slipping or unwanted movement. In one embodiment, anti-fatigue mat 100 includes electrical cord and adapter 104, electrical connect/disconnect 106, and manual control 108. Electrical cord and adapter 104 can be connected to a standard electrical outlet for powering various elements of anti-fatigue mat 100 further shown and described with reference to FIG. 3. Manual control 108 can include various controls including an on/off switch, various power settings, vibrating control for controlling the vibration within anti-fatigue mat 100, and heating control for controlling the heating element of anti-fatigue mat 100, further described with reference to FIG. 3. Electrical connect/disconnect 106 allows a user to remove or connect electrical cord and adapter 104 as needed.

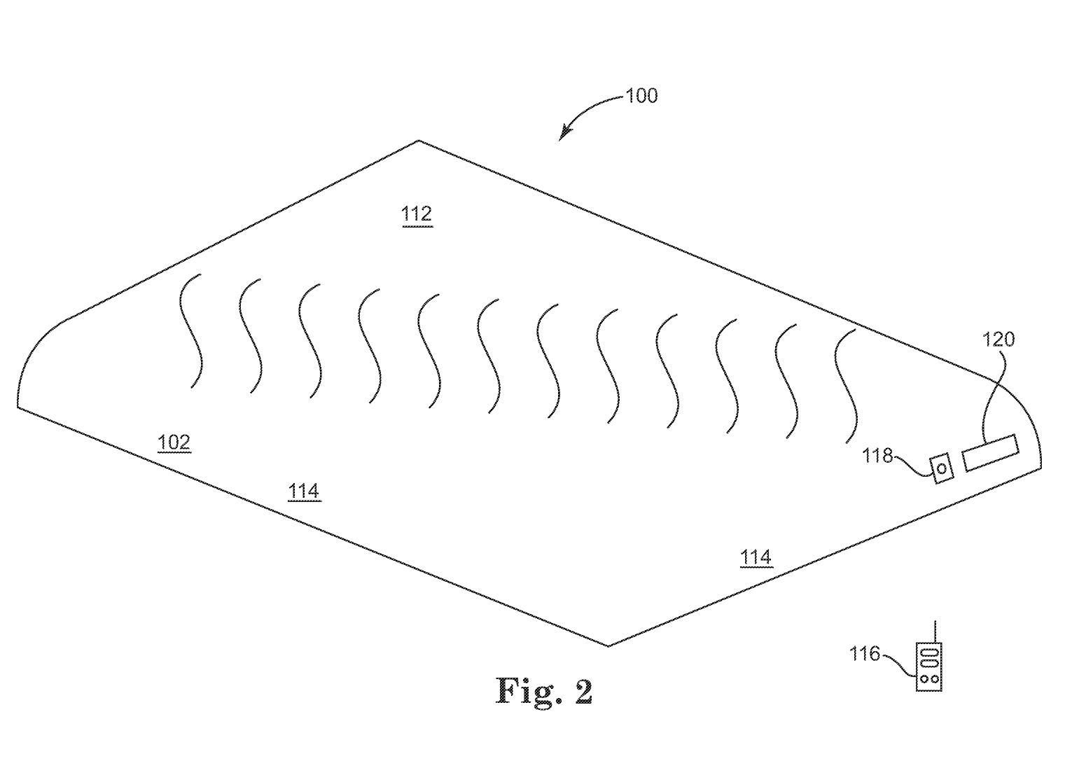

FIG. 2 is a perspective view of anti-fatigue mat 100. The anti-fatigue mat of FIG. 2 differs from the anti-fatigue mat of FIG. 1 in that the top edges of the anti-fatigue mat in FIG. 2 have been rounded so that a less dramatic step between the surface on which anti-fatigue mat 100 is placed and top surface 112 of anti-fatigue mat 100 is achieved. Further, electrical cord and adaptor 104 and electrical connect/disconnect 106 have been replaced with battery compartment 120. Thus, an alternative power source, batteries, is disclosed. Further, manual control 108 of FIG. 1 has been replaced by remote control transmitter 116 and remote control receiver 118. In this embodiment, a user can control various features of anti-fatigue mat 100, such as on/off, power level, vibrating level, and heating level, via remote control 116.

While electrical cord and adapter 104, electrical connect/disconnect 106, manual control 108, remote control receiver 118, and battery compartment 120 are shown at specific locations on or within anti-fatigue mat 100, it is understood that these components can be located anywhere on or within anti-fatigue mat 100 without deviating from the present disclosure.

FIG. 3 is a partial sectional view of anti-fatigue mat 100 in accordance with the present disclosure. Anti-fatigue mat 100 includes layers 122, 124, and 126, vibrating mechanism 128, electrical circuitry 130, heating mechanisms 132, electrical circuitry 134, pockets or voids 136, cooling mechanism 138, and electrical circuitry 140.

As shown in FIG. 3, layer 126 is constructed having a design incorporating circular-shaped voids or air spaces 136. However, it is understood that the air spaces 136 incorporated within layer 126 may be of any combination of material and air pockets, including a design with no air pockets, without deviating from the present disclosure. Further, air spaces or pockets 136 may be of any design or shape, such as honeycomb, or square, rectangular, without deviating from the present disclosure, and may include various materials, such as air, gels, or foams without deviating from the present disclosure. Pockets of spaces 136, which may be incorporated into one or more of layers 122-126, aid in the cushioning of anti-fatigue mat 100 and aid in the distribution and/or intensity of vibration from vibrating mechanisms 128 throughout anti-fatigue mat 100. Pockets of spaces 136 also aid in the distribution and/or intensity of heat from heating mechanisms 132 throughout anti-fatigue mat 100. Further, while three layers of material 122-126 are shown in FIG. 1, it is understood that an anti-fatigue mat 100 may have any number of layers without deviating from the present disclosure.

Layers 122-126 may be formed of any of a variety of materials or compressible composition, such as rubber, foam cushion, gels, or any combination thereof, that aid in the distribution and/or intensity of vibration and heat throughout anti-fatigue mat 100.

Vibrating mechanisms 128 of anti-fatigue mat 100 provide vibration or a vibration sensation to a user in varying degrees in conjunction with or separately from the heating feature of anti-fatigue mat 100. Vibrating mechanisms 128 can be any vibrating element or device without deviating from the present disclosure. Manual control 108 or remote control transmitter 116 allows the user to control or change the vibrating massage or function of vibrating mechanism 128 in a continuous or pulsed mode. Vibrating mechanism 128 can provide vibration in a timed pulse configuration, such as pulses per minute, and/or provide an intensity of a vibrating sensation in a continuous mode in a low vibration, a vigorous vibration, or any vibration therebetween. Further, the intensity and vigor of the vibration from vibrating mechanisms 128 can also be controlled by manual control 108 or remote control transmitter 116.

Heating mechanisms 132 of anti-fatigue mat 100 provide heat or a heat sensation to a user in varying degrees in conjunction with or separately from the massage feature of anti-fatigue mat 100. Heating mechanisms 132 can be any heating element, coil, or device without deviating from the present disclosure. Heating mechanism 132 can provide heat in a timed pulse configuration, such as pulses per second or pulses per minute, and/or providing a heating sensation in a continuous mode. Manual control 108 or remote control transmitter 116 allows the user to control or change the heating sensation of heating mechanisms 132 in pulsed or continuous heat.

Manual control 108, shown in FIG. 1, and remote control transmitter 116, shown in FIG. 2, can be used to turn on/off anti-fatigue mat 100 and to control vibrating mechanisms 128 and heating mechanisms 132. Remote control transmitter 116 can be either a wireless or wired device. Manual control 108 and remote control transmitter 116 may control the intensity of vibration and the temperature of heat provided by anti-fatigue mat 100, and may further include a timer to provide for specific time periods of power prior to turning off an individual, a combination or all electrical elements within anti-fatigue mat 100.

In one embodiment, anti-fatigue mat 100 may include cooling mechanism 138 and associated electrical circuitry 140 which will minimize heat from either vibrating mechanisms 128, heating mechanisms 132, or electrical circuitry 130 and 134. Cooling mechanism 138 may minimize or prevent heat damage or breakdown of components of anti-fatigue mat 100, while also minimizing or preventing anti-fatigue mat 100 from over-heating and causing discomfort to the user. Cooling mechanism 138 can be any cooling element or device without deviating from the present disclosure.

While vibrating mechanisms 128, heating mechanisms 132, and cooling mechanism 138 are shown in specific locations and on specific layers within anti-fatigue mat 100, it is understood that these mechanisms and associated electrical circuitry can be located anywhere within anti-fatigue mat 100 without deviating from the present disclosure. Further, any number of vibrating mechanisms 128, heating mechanisms 132, and cooling mechanisms 138 may be provided within anti-fatigue mat 100 without deviating from the present disclosure.

Layers 122-126 are formed from a material that will aid in the protection of vibrating mechanisms 128 heating mechanism 132 and electrical circuitry 130 and 134. Layers 122-126 will also provide durability to anti-fatigue mat 100 and will aid in the distribution of vibration and heat throughout anti-fatigue mat 100. Layers 122-126 can be formed of materials having various degrees of integrity and compressibility.

Enclosure 102, which acts as the outer surface of anti-fatigue mat 100, may include a durable cover to enclose the various layers, vibrating mechanisms 128, heating mechanisms 132, cooling mechanism 138, and electrical circuitry 130, 134, and 140. In one embodiment, enclosure 108 will be waterproof, scratch proof, and/or able to withstand damage from natural elements such as a the sun and rain, and man-made elements, such as use by a user by standing or laying on anti-fatigue mat 100.

In one embodiment, anti-fatigue mat 100 includes one or more variable resistors or other components for varying the amount of vibration, heating, or cooling of the vibrating mechanism 138, respectively. These variations can be caused by a user via the controls of manual control 108 or remote control transmitter 116. A microprocessor or other computing device may also be included within anti-fatigue mat 100 to aid in variations of vibration, heating, cooling, as well as any other adjustable features of anti-fatigue mat 100.

In one embodiment, anti-fatigue mat 100 may include an auto shut-off feature either based upon length of time anti-fatigue mat 100 has been powered on, or based upon an internal temperature within anti-fatigue mat 100. The auto shut-off feature will minimize or prevent burn out of anti-fatigue mat 100 or individual components of anti-fatigue mat 100.

Use of anti-fatigue mat 100 will provide substantial comfort to the user, especially in industries in which a user must stand for a prolonged period of time, such as hairdressers, bartenders, cashiers, assembly line workers, security guards, lunch line workers, bank tellers, etc. Anti-fatigue mat 100 incorporates various materials, such as foam, rubber, or gels, to aid in the comfort provided to the user. In addition, the use of stimulation by vibration and/or stimulation by heat to the user will aid in the circulation of blood flow throughout the body part in contact with anti-fatigue mat 100 as well as other body parts. Thus, in many instances where a user is standing on anti-fatigue mat 100, increased blood flow to a user's feet and legs will be provided, thereby minimizing fatigue of the lower extremities and back of the user. Anti-fatigue mat 100 may also be used in environments where a user is kneeling, sitting, or laying on anti-fatigue mat 100 to provide comfort, prevent fatigue, and aid in blood circulation throughout the body.

Although the present disclosure has been described with reference to preferred embodiments, workers skilled in the art will recognize that changes can be made in form and detail without departing from the spirit and scope of the present disclosure.

What is claimed is:

1. An anti-fatigue mat comprising:
an enclosure;
at least one electrical circuitry positioned within the enclosure for providing an electrical current;
at least one vibrating mechanism coupled to the at least one electrical circuitry for receiving the electrical current and for vibrating in response to the electrical current, thereby providing a vibrating sensation;
a compressible composition positioned within the enclosure.

2. The anti-fatigue mat of claim 1, and further comprising:
at least one heating mechanism coupled to the electric circuitry for receiving an electric current and for providing a heat sensation.

3. The anti-fatigue mat of claim 1, wherein the compressible composition further comprises:
a compressible composition having a configuration incorporating a plurality of apertures.

4. The anti-fatigue mat of claim 1, wherein the compressible composition further comprises:
a compressible material having a honeycomb configuration.

5. The anti-fatigue mat of claim 1, and further comprising:
a plurality of layers of the compressible composition having varying degrees of integrity and compressibility.

6. The anti-fatigue mat of claim 1, wherein the compressible composition further comprises one or more from the group consisting:
a foam composition, a gel composition and a rubber composition.

7. The anti-fatigue mat of claim 1, and further comprising:
an electrical connection coupled to the at least one electrical circuitry capable of connecting to a 110-volt electrical source.

8. The anti-fatigue mat of claim 1, and further comprising:
an electrical connection coupled to the at least one electrical circuitry capable of connecting to a battery source.

9. The anti-fatigue mat of claim 1, and further comprising:
a manual control coupled to the at least one electrical circuitry for controlling the vibrating sensation of the vibrating mechanism.

10. The anti-fatigue mat of claim 1, and further comprising:
a remote control for controlling the at least one electrical circuitry for controlling the vibrating sensation of the vibrating mechanism.

11. An anti-fatigue mat comprising:
an enclosure;
at least one electrical circuitry positioned within the enclosure for providing an electrical current;
at least one heat mechanism positioned within the enclosure coupled to the at least one electrical circuitry for receiving the electrical current and for providing a heat sensation; and
a compressible composition positioned within the enclosure.

12. The anti-fatigue mat of claim 11, and further comprising:
at least one vibrating mechanism coupled to the electric circuitry for receiving an electric current and for providing a vibrating sensation.

13. The anti-fatigue mat of claim 11, wherein the compressible composition further comprises:
a compressible composition having a configuration incorporating a plurality of apertures.

14. The anti-fatigue mat of claim 11, wherein the compressible composition further comprises:
a compressible material having a honeycomb configuration.

15. The anti-fatigue mat of claim 11, and further comprising:
a plurality of layers of the compressible composition having varying degrees of integrity and compressibility.

16. The anti-fatigue mat of claim 11, wherein the compressible composition further comprises one or more from the group consisting:
a foam composition, a gel composition and a rubber composition.

17. The anti-fatigue mat of claim 11, and further comprising:
an electrical connection coupled to the at least one electrical circuitry capable of connecting to a 110-volt electrical source.

18. The anti-fatigue mat of claim 11, and further comprising:
an electrical connection coupled to the at least one electrical circuitry capable of connecting to a battery source.

19. The anti-fatigue mat of claim 11, and further comprising:
a manual control coupled to the at least one electrical circuitry for controlling the vibrating sensation of the vibrating mechanism.

20. The anti-fatigue mat of claim 11, and further comprising:
a remote control for controlling the at least one electrical circuitry for controlling the vibrating sensation of the vibrating mechanism.
